(19) United States
(12) Patent Application Publication
(10) Pub. No.: US 2005/0248577 A1
(43) Pub. Date: Nov. 10, 2005

(54) Method for separately blending low frequency and high frequency information for animation of a character in a virtual environment

(75) Inventor: Kenneth J. Birdwell, Bellevue, WA (US)

Correspondence Address: DARBY & DARBY P.C., P. O. BOX 5257, NEW YORK, NY, 10150-5257, US

(73) Assignee: Valve Corporation, Bellevue, WA (US)

(21) Appl. No.: 10/841,252

(22) Filed: May 7, 2004

(51) Int. Cl. G06T 15/70; G06T 13/00; G06F 17/00

(52) U.S. Cl. 345/474

(57) ABSTRACT

The method enables the blending of high frequency information and low frequency information at different rates to generate a relatively realistic animation of a character in a virtual environment. Typically, the high frequency information corresponds to a characteristic motion of a character and the low frequency information corresponds to gross changes in a pose of the character. In advance of the actual rendering, an animation is first separated into high frequency and low frequency information that can be separately blended to render a relatively realistic animation for the character in a virtual environment. The separate blending of high and low frequency information enables an animation for a character to be readily adapted to different scenes in a virtual environment.

### FIELD OF THE INVENTION

The present invention relates to animation in a virtual environment, and in particular, but not exclusively, to enabling the blending of low frequency and high frequency animation for a character in the virtual environment.

### BACKGROUND OF THE INVENTION

As many devoted computer gamers may be aware, the overall interactive entertainment of a computer game may be greatly enhanced with the presence of realistic visual effects. However, creating a robust and flexible visual effects application that is also computationally efficient is a considerable challenge. Such visual effects applications may be difficult to design, challenging to code, and even more difficult to debug. Creating the visual effects application to operate realistically in real-time may be even more difficult.

Today, there are a number of off-the-shelf visual effects applications that are available, liberating many game developers, and other dynamic three-dimensional virtual environment program developers, from the chore of programming this component, themselves. However, the integration of a visual effects application with a game model that describes the virtual environment and its characters often remains complex. An improper integration of the visual effects application with the game model may be visible to the computer gamer by the less than “life-like” animation of a character, as well as other non-realistic visualizations, reactions, and delays. Such visual artifacts tend to diminish the overall enjoyment in a virtual environment. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 illustrates one embodiment of an environment in which the invention operates;

FIG. 2 shows a functional block diagram of one embodiment of a network device configured to operate with a game server;

FIG. 3 illustrates a function block diagram of one embodiment of the game server of FIG. 2;

FIG. 4 shows a pictorial diagram of an animation for a character with separately blended high and low frequency information;

FIG. 5 illustrates another pictorial diagram of another animation for a character with separately blended high and low frequency information;

FIG. 6 shows a graph for scripting separate blending of high and low frequency information for compositing an animation of a character in a virtual environment;

FIG. 7 illustrates another graph for scripting separate blending of high and low frequency information for compositing an animation of a character in a virtual environment;

FIG. 8 shows a flow diagram generally showing one embodiment of a pre-processing low frequency information and high frequency information for a subsequent animation of a character in a virtual environment; and

FIG. 9 illustrates another flow diagram generally showing one embodiment of a process for rendering an animation for a character in a virtual environment based on separate blending of high frequency and low frequency information, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Briefly stated, the present invention is directed to a system, apparatus, and method for enabling the blending of high frequency information and low frequency information at different rates to generate a relatively realistic animation of a character in a virtual environment. Typically, the high frequency information corresponds to a characteristic motion of a character and the low frequency information corresponds to gross changes in a pose of the character. In advance of the actual rendering, an animation is first separated into high frequency and low frequency information that can be separately blended to render a relatively realistic animation for the character in a virtual environment.

In one example, the subsequent rendering of the animation can employ the high frequency information to relatively immediately generate the characteristic motion and the low frequency data can be employed over a relatively longer period of time to generate a gross change in a pose of the character in a virtual environment, such as a video game, chat room, virtual world, movie, machinima, and the like. In another example, the high frequency information can be employed to generate the characteristic motion after the character's gross change in pose over a relatively long period of time is substantially complete, which is based on the low frequency information. As shown by these two examples, the separate blending of high and low frequency information enables an animation for a character to be readily adapted to different scenes in a virtual environment.

Additionally, in part because an animation is pre-processed into high and low frequency information that can be separately blended at different rates over different periods of time, subsequent generation of relatively realistic animations for a character in different scenes of a virtual environment can be accomplished without relying upon a custom authored animation for each scene.

Furthermore, the character is a virtual representation of an animated entity, including but not limited to a human, fish, bird, serpent, mammal, fish, monster, alien, and the like. In one embodiment, a virtual skeleton can be employed for bone based animations of the character. Hierarchical movements of the bones in the virtual skeleton can be employed to animate the character. In another embodiment, skeleton-morph animations with soft-skinned and/or hard-skinned vertices can be employed with the character. In yet another embodiment, face and body animations based on a deformable and relatively seamless mesh can be employed with the character.

Illustrative Operating Environment

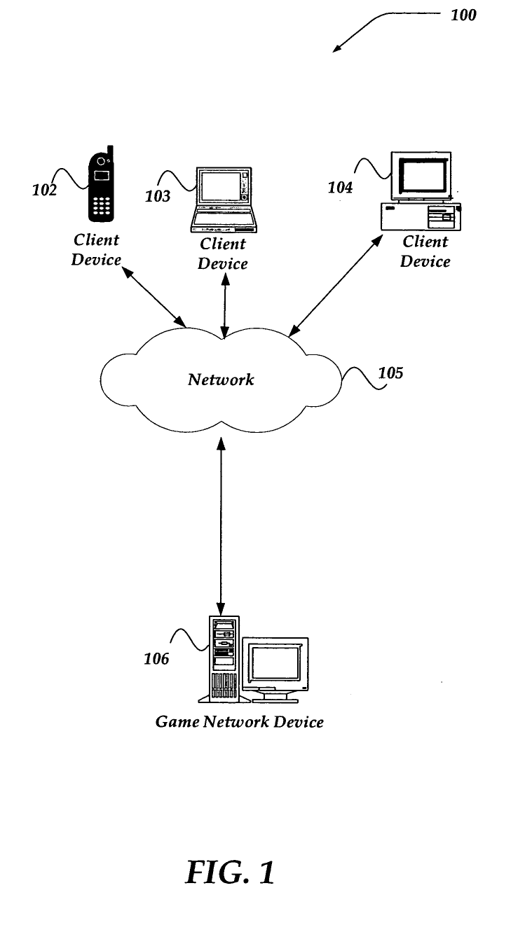

FIG. 1 illustrates one embodiment of an environment in which the invention may operate. However, not all of these components may be required to practice the invention, and variations in the arrangement and type of the components may be made without departing from the spirit or scope of the invention.

As shown in the figure, system 100 includes client devices 102-104, network 105, and Game Network Device (GND) 106. Network 105 enables communication between client devices 102-104, and GND 106.

Generally, client devices 102-104 may include virtually any computing device capable of connecting to another computing device to send and receive information, including game information, and other interactive information. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, radio frequency (RF) devices, infrared (IR) devices, integrated devices combining one or more of the preceding devices, or virtually any mobile device, and the like. Similarly, client devices 102-104 may be any device that is capable of connecting using a wired or wireless communication medium such as a PDA, POCKET PC, wearable computer, and any other device that is equipped to communicate over a wired and/or wireless communication medium.

Client devices 102-104 may further include a client application, and the like, that is configured to manage the actions described above.

Moreover, client devices 102-104 may also include a game client application, and the like, that is configured to enable an end-user to interact with and play a game, an interactive program, and the like. The game client may be configured to interact with a game server program, or the like. In one embodiment, the game client is configured to provide various functions, including, but not limited to, authentication, ability to enable an end-user to customize a game feature, synchronization with the game server program, and the like. The game client may further enable game inputs, such as keyboard, mouse, audio, and the like. The game client may also perform some game related computations, including, but not limited to, audio, game logic, physics computations, visual rendering, and the like. In one embodiment, client devices 102-104 are configured to receive and store game related files, executables, audio files, graphic files, and the like, that may be employed by the game client, game server, and the like.

In one embodiment, the game server resides on another network device, such as GND 106. However, the invention is not so limited. For example, client devices 102-104 may also be configured to include the game server program, and the like, such that the game client and game server may interact on the same client device, or even another client device. Furthermore, although the present invention is described employing a client/server architecture, the invention is not so limited. Thus, other computing architectures may be employed, including but not limited to peer-to-peer, and the like.

Network 105 is configured to couple client devices 102-104, and the like, with each other, and to GND 106. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, to enable messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art.

Network 105 may further employ a plurality of wireless access technologies including, but not limited to, 2nd (2G), 3rd (3G), 4^{th} (4G) generation radio access for cellular systems, Wireless-LAN, Wireless Router (WR) mesh, and the like. Access technologies such as 2G, 3G, 4G and future access networks may enable wide area coverage for mobile devices, such as client device 102 with various degrees of mobility. For example, network 105 may enable a radio connection through a radio network access such as Global System for Mobil communication (GSM), General Packet Radio Services (GPRS), Enhanced Data GSM Environment (EDGE), Wideband Code Division Multiple Access (WCDMA), Code Division Multiple Access 2000 (CDMA 2000) and the like.

Furthermore, remote computers and other related electronic devices could be remotely connected to either LANs or WANs via a modem and temporary telephone link. In essence, network 105 includes any communication method by which information may travel between client devices 102-104 and GND 106, and the like.

Additionally, network 105 may include communication media that typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as, but not limited to, twisted pair, coaxial cable, fiber optics, wave guides, and other wired media and wireless media such as, but not limited to, acoustic, RF, infrared, and other wireless media.

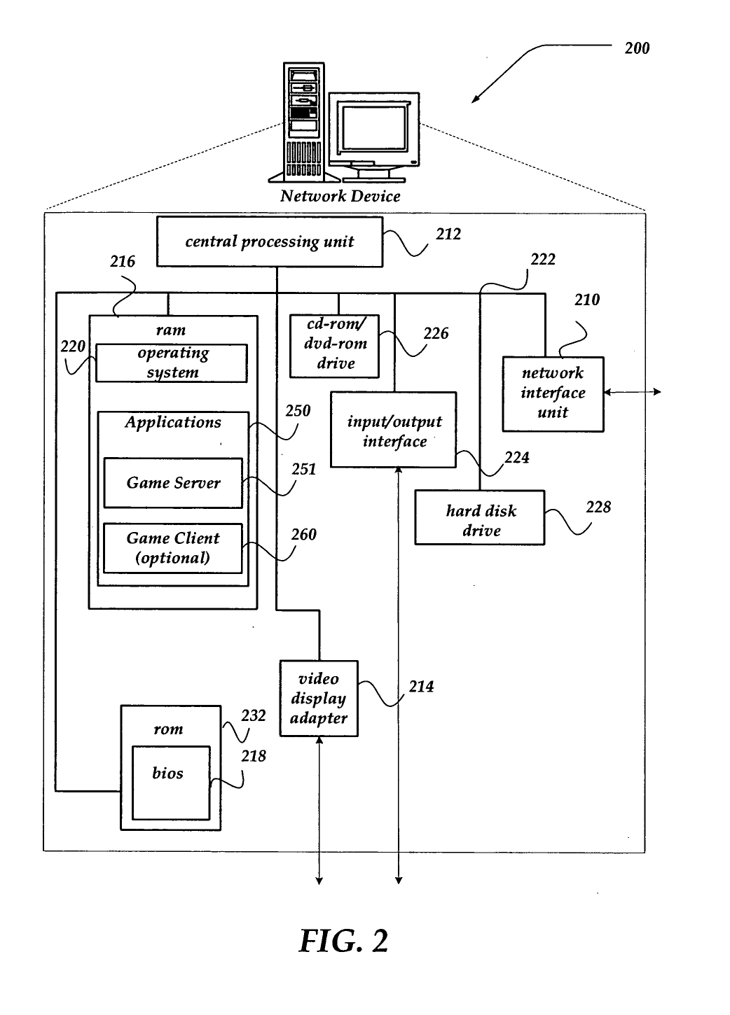

GND 106 is described in more detail below in conjunction with FIG. 2. Briefly, however, GND 106 includes virtually any network device configured to include the game server program, and the like. As such, GND 106 may be implemented on a variety of computing devices including personal computers, desktop computers, multiprocessor systems, microprocessor-based devices, network PCs, servers, network appliances, and the like.

GND 106 may further provide secured communication for interactions and accounting information to speedup periodic update messages between the game client and the game server, and the like. Such update messages may include, but are not limited to a position update, velocity update, audio update, graphics update, authentication information, and the like.

Illustrative Server Environment

FIG. 2 shows one embodiment of a network device, according to one embodiment of the invention. Network device 200 may include many more components than those shown. The components shown, however, are sufficient to disclose an illustrative embodiment for practicing the invention. Network device 200 may represent, for example, GND 106 of FIG. 1.

Network device 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of network device 200. Any general-purpose operating system may be employed. Basic input/output system (“BIOS”) 218 is also provided for controlling the low-level operation of network device 200. As illustrated in FIG. 2, network device 200 also can communicate with the Internet, or some other communications network, such as network 105 in FIG. 1, via network interface unit 210, which is constructed for use with various communication protocols including the TCP/IP protocols. For example, in one embodiment, network interface unit 210 may employ a hybrid communication scheme using both TCP and IP multicast with a client device, such as client devices 102-104 of FIG. 1. Network interface unit 210 is sometimes known as a transceiver, network interface card (NIC), and the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs may include transcoders, schedulers, graphics programs, database programs, word processing programs, HTTP programs, user interface programs, various security programs, and so forth. Mass storage may further include applications such as game server 251 and optional game client 260.

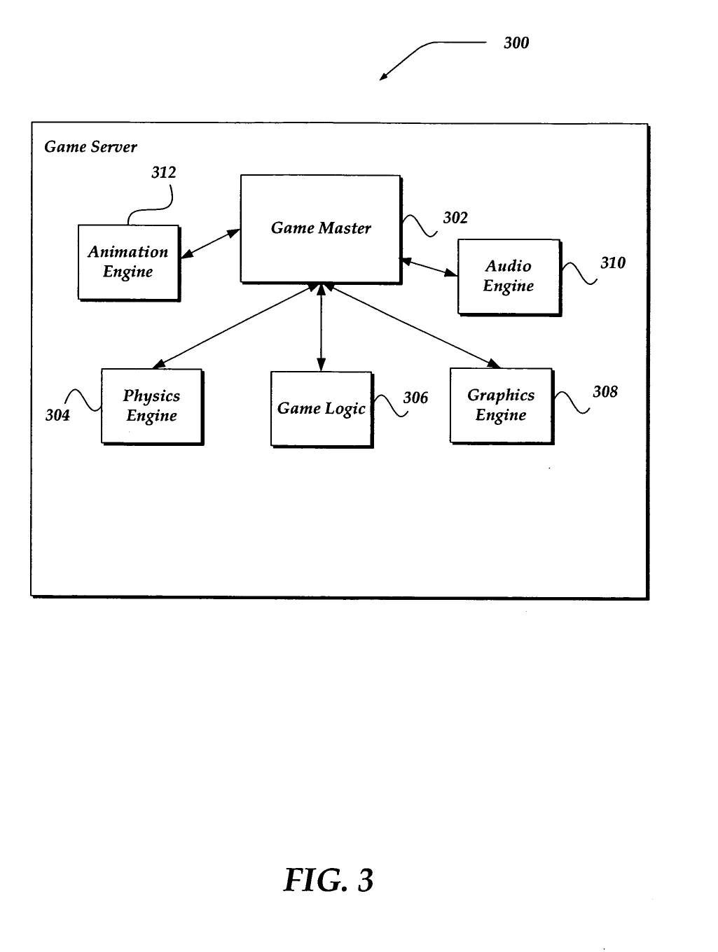

One embodiment of game server 251 is described in more detail in conjunction with FIG. 3. Briefly, however, game server 251 is configured to enable an end-user to interact with a game, and similar three-dimensional modeling programs. In one embodiment, game server 251 interacts with a game client residing on a client device, such as client devices 102-105 of FIG. 1 and/or optional game client 260 residing on network device 200. Game server 251 may also interact with other components residing on the client device, another network device, and the like. For example, game server 251 may interact with a client application, security application, transport application, and the like, on another device.

Network device 200 may also include an SMTP handler application for transmitting and receiving e-mail, an HTTP handler application for receiving and handing HTTP requests, and an HTTPS handler application for handling secure connections. The HTTPS handler application may initiate communication with an external application in a secure fashion. Moreover, network device 200 may further include applications that support virtually any secure connection, including but not limited to TLS, TTLS, EAP, SSL, IPSec, and the like.

Network device 200 also includes input/output interface 224 for communicating with external devices, such as a mouse, keyboard, scanner, or other input devices not shown in FIG. 2. Likewise, network device 200 may further include additional mass storage facilities such as CD-ROM/DVD-ROM drive 226 and hard disk drive 228. Hard disk drive 228 may be utilized to store, among other things, application programs, databases, client device information, policy, security information including, but not limited to certificates, ciphers, passwords, and the like.

FIG. 3 illustrates a function block diagram of one embodiment of a game server for use in GND 106 of FIG. 1. As such, game server 300 may represent, for example, game server 251 of FIG. 2. Game server 300 may include many more components than those shown. The components shown, however, are sufficient to disclose an illustrative embodiment for practicing the invention. It is further noted that virtually any distribution of functions may be employed across and between a game client and game server. Moreover, the present invention is not limited to any particular architecture, and another may be employed. However, for ease of illustration of the invention, a client/server architecture has been selected for discussion below. Thus, as shown in the figure, game server 300 includes game master 302, physics engine 304, game logic 306, graphics engine 308, audio engine 310, and animation engine 312.

Game master 302 may also be configured to provide authentication, and communication services with a game client, another game server, and the like. Game master 302 may receive, for example, input events from the game client, such as keys, mouse movements, and the like, and provide the input events to game logic 306, physics engine 304, graphics engine 308, audio engine 310, animation engine 312, and the like. Game master 302 may further communicate with several game clients to enable multiple players, and the like. Game master 302 may also monitor actions associated with a game client, client device, another game server, and the like, to determine if the action is authorized. Game master 302 may also disable an input from an unauthorized sender.

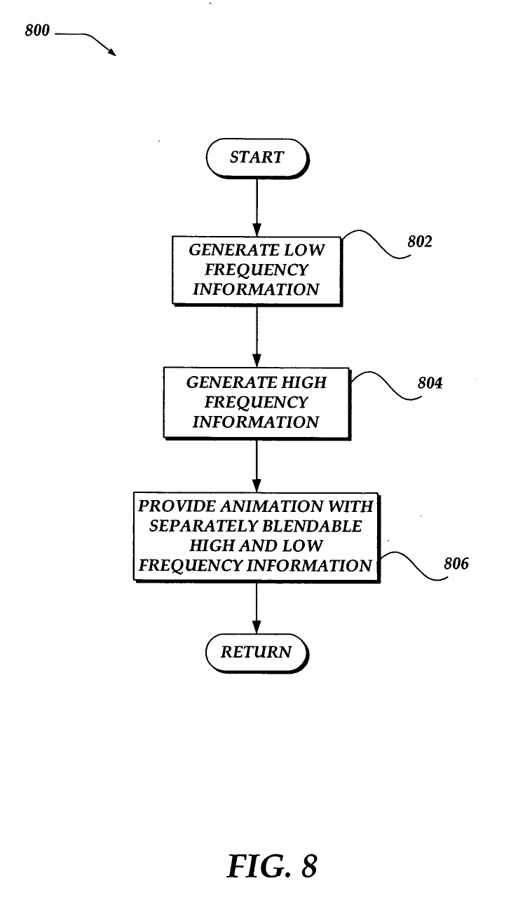

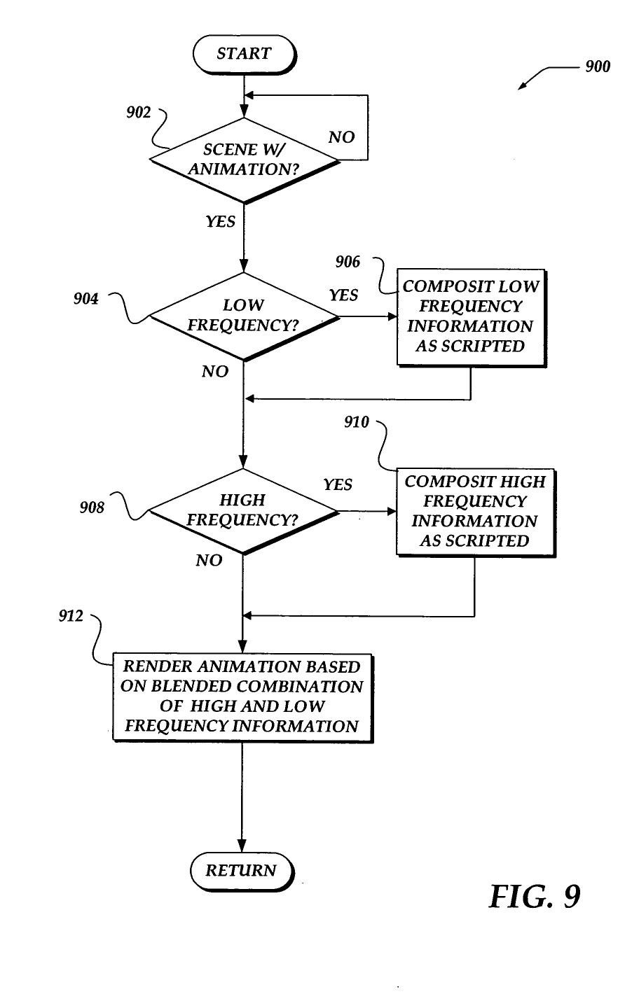

Game master 302 may further manage interactions between physics engine 304, game logic 306, graphics engine 308, audio engine 310 and animation engine 312. For example, in one embodiment, game master 302 may perform substantially similar to the processes described below in conjunction with FIGS. 8 and 9.

Game logic 306 is also in communication with game master 302, and is configured to provide game rules, goals, and the like. Game logic 306 may include a definition of a game logic entity within the game, such as an avatar, vehicle, and the like. Game logic 306 may include rules, goals, and the like, associated with how the game logic entity may move, interact, appear, and the like, as well. Game logic 306 may further include information about the environment, and the like, in which the game logic entity may interact. Game logic 306 may also included a component associated with artificial intelligence, neural networks, and the like.

Physics engine 304 is in communication with game master 302. Physics engine 304 is configured to provide mathematical computations for interactions, movements, forces, torques, collision detections, collisions, and the like. In one embodiment, physics engine 304 is a provided by a third party. However, the invention is not so limited and virtually any physics engine 304 may be employed that is configured to determine properties of entities, and a relationship between the entities and environments related to the laws of physics as abstracted for a virtual environment.

Physics engine 304 may determine the interactions, movements, forces, torques, collisions, and the like for a physic's proxy. Virtually every game logic entity may have associated with it, a physic's proxy. The physic's proxy may be substantially similar to the game logic entity, including, but not limited to shape. In one embodiment, however, the physic's proxy is reduced in size from the game logic entity by an amount epsilon. The epsilon may be virtually any value, including, but not limited to a value substantially equal to a distance the game logic entity may be able to move during one computational frame.

Graphics engine 308 is in communication with game master 302 and is configured to determine and provide graphical information associated with the overall game. As such, graphics engine 308 may include a bump-mapping component for determining and rending surfaces having high-density surface detail. Graphics engine 308 may also include a polygon component for rendering three-dimensional objects, an ambient light component for rendering ambient light effects, and the like. However, graphics engine 308 is not limited to these components, and others may be included, without departing from the scope or spirit of the invention. For example, additional components may exist that are employable for managing and storing such information, as map files, entity data files, environment data files, color palette files, texture files, and the like.

Audio engine 310 is in communication with game master 302 and is configured to determine and provide audio information associated with the overall game. As such, audio engine 310 may include an authoring component for generating audio files associated with position and distance of objects in a scene of the virtual environment. Audio engine 310 may further include a mixer for blending and cross fading channels of spatial sound data associated with objects and a character interacting in the scene.

Animation engine 312 is in communication with game master 302 and is configured to determine and provide the low and high frequency information for rendering animations for a character in the virtual environment. As such, animation engine 312 may include a component for generating low frequency information and high frequency information for an animation. Animation engine 312 may further include an authoring facility for generating an animation for a scene based on separate blending of the low frequency information and the high frequency information.

In another embodiment, a game client can be employed to assist with or solely perform single or combinatorial actions associated with game server 300, including those actions associated with game master 302, animation engine 312, audio engine 310, graphics engine 308, game logic 306, and physics engine 304.

Illustrative Pictorial Animations

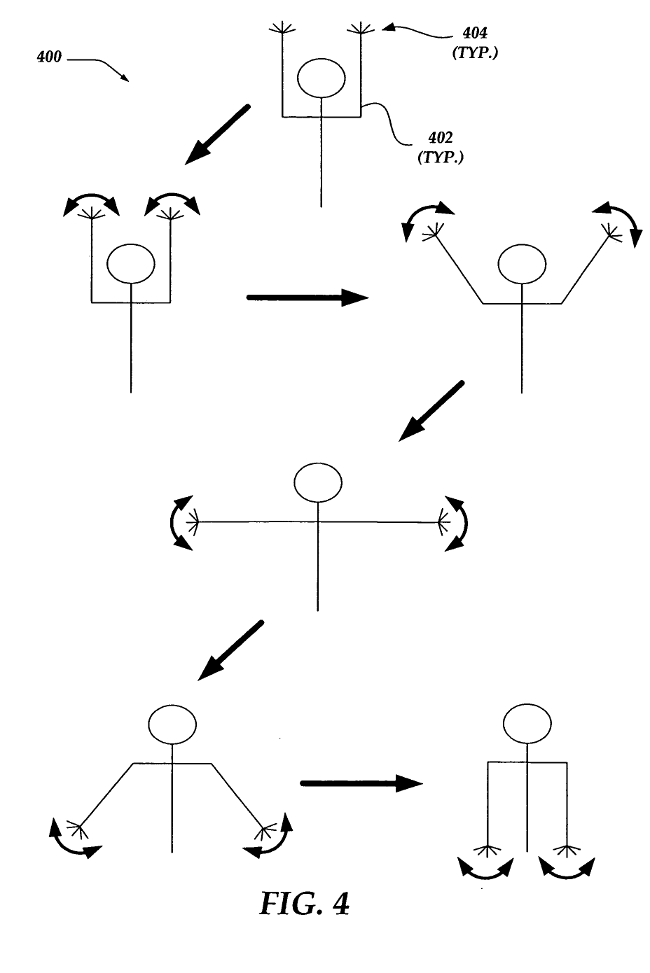

FIG. 4 shows a pictorial diagram illustrating an overview 400 of an animation for a character with separately blended high and low frequency information. In this example, the low frequency information is the gross change in a pose of the arms from a raised position to the lowered position. Also, the high frequency information is the vigorous shaking of the hands.

Prior to the animation, arms 402 are posed in a raised position above the head of the character and hands 404 are not moving. As shown, hands 404 immediately start to shake vigorously as arms 402 move from the raised position to the lowered position over a relatively longer period of time.

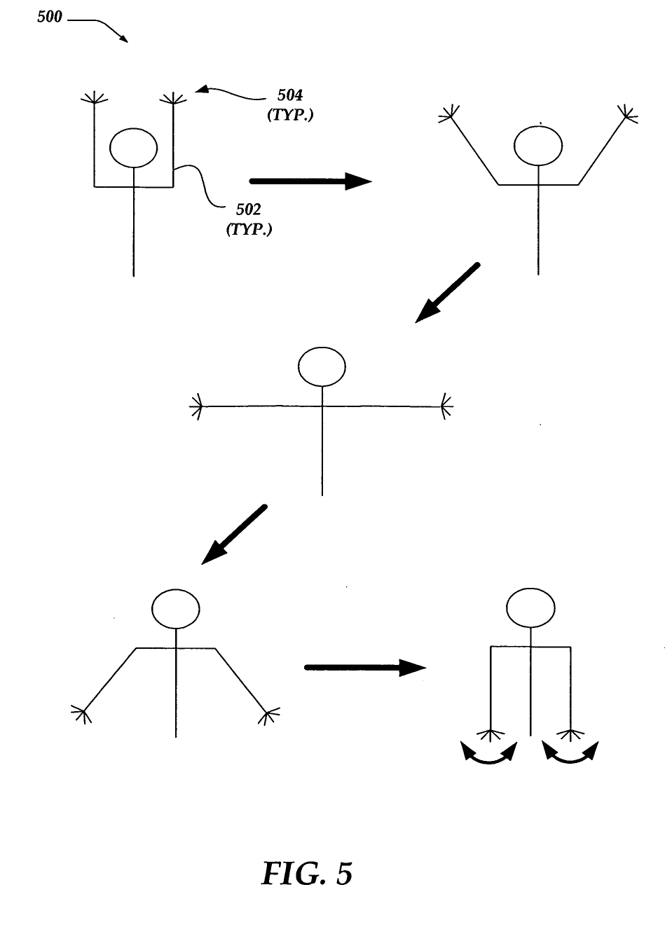

FIG. 5 illustrates another pictorial diagram illustrating an overview 500 of another animation for a character with separately blended high and low frequency information. In this example, the low and high frequency information for an animation can be separately blended so that hands 504 appear to shake in a vigorous manner relatively immediately after the pose of arms 502 has changed from a raised position to a lowered position.

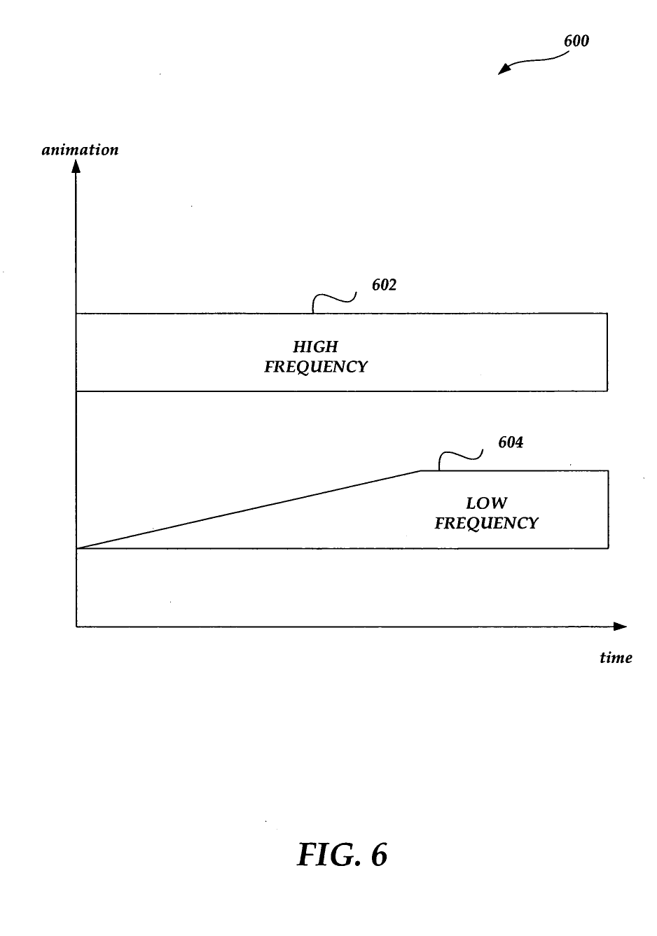

FIG. 6 shows graph 600 for illustrating the separate blending of high frequency information 602 and low frequency information 604 for compositing an animation of a character in a virtual environment. In this example, the low frequency information is the gross change in a pose of the character and the high frequency information is a characteristic motion. As shown, the high frequency is immediately composited at 100% and the low frequency component is ramped up over a period of time to 100%. In one embodiment, the high frequency component may be ramped up to 100% as well, but sooner and at a relatively faster rate than the low frequency component.

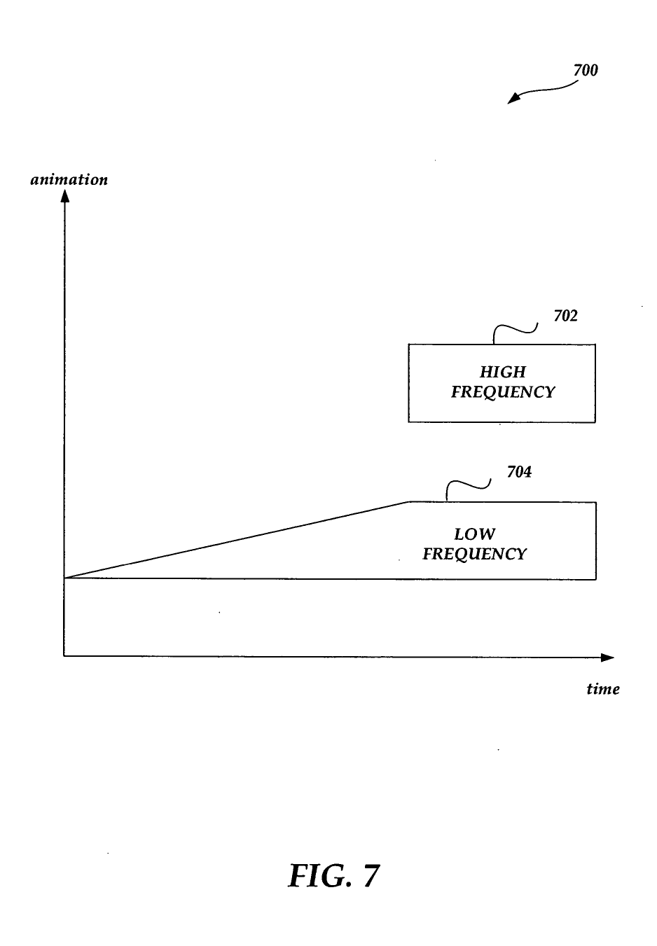

FIG. 7 illustrates another graph 700 for showing separate blending of high and low frequency information for compositing an animation of a character in a virtual environment. In this example, the low frequency information is the gross change in a pose of the character and the high frequency information is a characteristic motion. As shown, the low frequency component is ramped up over a period of time to 100% and the high frequency is immediately composited at 100% after the low frequency component has reached 100%.

Although not shown, a script for a scene can be employed to composit high frequency information over one period of time at one rate, and another script for the same scene can be employed to composit low frequency information over another period of time at another rate. Also, one script can be employed to composit both the low and high frequency information over different periods of time at different rates.

Additionally, separate scripts can be employed for different scenes that differently blend the low and high frequency information. A script can include a time curve for compositing the low and/or high frequency information for an animation. The time curve could be authored, predetermined, or arbitrary. Similarly, the rate or shape of this time curve can be authored, predetermined or arbitrary, including ramp, step, linear, logarithmic, exponential, piece-wise, sinusoidal, and the like.

Illustrative Flowcharts

FIG. 8 shows a flow diagram of process 800 for pre-processing the low frequency information and high frequency information for a subsequent animation of a character in a virtual environment. Moving from a start block, the process flows to block 802 where the low frequency information for the animation is generated. Typically, the low frequency information is directed to a gross change in a pose of a character. At block 804, the high frequency information for the animation is generated. Generally, the high frequency information is directed to characteristic motion of the character, such as the waving of hands, facial expressions, and the like.

At block 806, the process provides another process or sub-process with the animation which includes both the high and low frequency information. This information is separately blendable when the animation is eventually rendered for a scene in the virtual environment. Next, the process returns to performing other actions.

In one embodiment, the low and/or high frequency information can be automatically extracted from the bone velocities associated with a character. In another embodiment, the low and/or high frequency information can be automatically extracted from the changes (delta) in the position of the character as it moves from one pose to another.

FIG. 9 illustrates another flow diagram of process 900 for rendering an animation for a character in a virtual environment based on separate blending of high frequency and low frequency information. The separate blending of high frequency and low frequency information enables transitioning from an arbitrarily positioned previous animation state to a new animation state in a relatively more life-like and realistic manner. Moving from a start block, the process flows to decision block 902 where a determination is made as to whether an animation for the character is to be played/rendered in a scene of the virtual environment. If false, the process loops until the determination is true.

Once the determination at decision block 902 is true, the process steps to decision block 904 where a determination is made as to whether the low frequency information for the animation is scripted. If true, the process moves to block 906 where the scripted low frequency information is composited.

Next, the process flows to decision block 908 where another determination is made as to whether the high frequency information for the animation is scripted. Alternatively, if the determination at decision block 904 had been false, the process would have also moved to decision block 908. In either case, if the determination at decision block 908 is true, the process moves to block 910 where the scripted high frequency information is composited. From block 910, the process steps to block 912 where the animation is rendered for the character in the virtual environment based on a separately blended combination of composited high and low information. Next, the process returns to performing other actions.

Moreover, it will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

1. A method for animating a character in a virtual environment, comprising:
determining low frequency information associated with a gross change in a pose of the character;
determining high frequency information associated with a characteristic motion for the character; and
enabling separate blending of low frequency information and high frequency information for the rendering of an animation of the character in a scene of the virtual environment, wherein the separate blending enables the animation of the change in the gross pose to occur over a first period of time at a first rate and the animation of the characteristic motion to occur over a second period of time at a second rate.

2. The method of claim 1, wherein the animation of the character is bone-based, and wherein the change in the gross pose is a higher hierarchical bone movement than a lower hierarchical bone movement for the characteristic motion.

3. The method of claim 1, wherein the change in the gross pose includes at least one of repositioning at least one virtual limb of the character, bending a virtual torso of the character and changing an orientation of a virtual body of the character.

4. The method of claim 1, wherein the characteristic motion includes shaking at least one of a virtual hand, virtual torso, virtual head, virtual foot, virtual wing, and virtual fin.

5. The method of claim 1, further comprising:
employing a script for compositing low frequency information at the first rate over the first period of time in the scene; and
employing the script for compositing high frequency information at the second rate over the second period of time in the scene.

6. The method of claim 5, further comprising
employing another script for compositing low frequency information at a third rate over a third period of time in another scene; and
employing the other script for compositing high frequency information at a fourth rate over a fourth period of time in the other scene.

7. The method of claim 1, wherein each period of time is at least one of authored, pre-determined, and arbitrary.

8. The method of claim 1, wherein each rate is at least one of authored, predetermined, and arbitrary.

9. The method of claim 1, wherein the virtual environment is at least one of a video game, chat room, movie, machinina, and virtual world.

10. The method of claim 1, wherein the character is a virtual representation of an animated entity, including at least one of a human, a fish, a bird, a serpent, a mammal, a fish, a monster, and an alien.

11. The method of claim 1, wherein the animation of the character is at least one of bone based, skeleton-morph, and deformable seamless mesh.

12. A server for animating a character in a virtual environment, comprising:
a memory for storing data; and
an animation engine for performing actions, including:
determining low frequency information associated with a gross change in a pose of the character;
determining high frequency information associated with a characteristic motion for the character; and
enabling separate blending of low frequency information and high frequency information for the rendering of an animation of the character in a scene of the virtual environment, wherein the separate blending enables a first period of time for the animation of the change in the gross pose at a first rate to be different than another period of time for the animation of the characteristic motion at a second rate.

13. The server of claim 12, wherein the animation of the character is bone-based, and wherein the change in the gross pose is a higher hierarchical bone movement than a lower hierarchical bone movement for the characteristic motion.

14. The server of claim 12, further comprising:
employing a script for compositing low frequency information over the first period of time in the scene; and
employing the script for compositing high frequency information over the second period of time in the scene.

15. The server of claim 14, further comprising
employing another script for compositing low frequency information over a third period of time in another scene; and
employing the other script for compositing high frequency information over a fourth period of time in the other scene.

16. The server of claim 12, wherein each period of time is at least one of authored, pre-determined, and arbitrary, and wherein each rate is at least one of authored, predetermined, and arbitrary.

18. The server of claim 12, wherein the virtual environment is at least one of a video game, chat room, movie, machinina, and virtual world.

19. The server of claim 12, wherein the character is a virtual representation of an animated entity, including at least one of a human, a fish, a bird, a serpent, a mammal, a fish, a monster, and an alien.

20. A client for animating a character in a virtual environment, comprising:
a memory for storing data; and
an animation engine for performing actions, including:
determining low frequency information associated with a gross change in a pose of the character;
determining high frequency information associated with a characteristic motion for the character; and
enabling separate blending of low frequency information and high frequency information for the rendering of an animation of the character in a scene of the virtual environment, wherein the separate blending enables a first period of time for the animation of the change in the gross pose at a first rate to be different than another period of time for the animation of the characteristic motion at a second rate.

21. The client of claim 20, wherein the animation of the character is bone-based, and wherein the change in the gross pose is a higher hierarchical bone movement than a lower hierarchical bone movement for the characteristic motion.

22. The client of claim 20, further comprising:
employing a script for compositing low frequency information over the first period of time at the first rate in the scene; and
employing the script for compositing high frequency information over the second period of time at the second rate in the scene.

23. The client of claim 22, further comprising
employing another script for compositing low frequency information over a third period of time at a third rate in another scene; and
employing the other script for compositing high frequency information over a fourth period of time at a fourth rate in the other scene.

24. The client of claim 20, wherein each period of time is at least one of authored, pre-determined, and arbitrary, and wherein each rate is at least one of authored, predetermined, and arbitrary.

25. The client of claim 20, wherein the virtual environment is at least one of a video game, chat room, movie, machinina, and virtual world.

26. The client of claim 15, wherein the character is a virtual representation of an animated entity, including at least one of a human, a fish, a bird, a serpent, a mammal, a fish, a monster, and an alien.

27. A carrier wave signal that includes data for performing actions, comprising:
determining low frequency information associated with a gross change in a pose of a character in a virtual environment;
determining high frequency information associated with a characteristic motion for the character in the virtual environment; and
enabling separate blending of low frequency information and high frequency information for the rendering of an animation of the character in a scene of the virtual environment, wherein the separate blending enables a first period of time for the animation of the change in the gross pose at a first rate to be different than second period of time for the animation of the characteristic motion at a second rate.
